(19) United States
(12) Patent Application Publication
(10) Pub. No.: US 2025/0238730 A1
(43) Pub. Date: Jul. 24, 2025

(54) PERTURBATION RESPONSE AND TARGET CELL STATE MODELING

(71) Applicant: Altos Labs, Inc., Redwood City, CA (US)

(72) Inventors: Esther E. WERSHOF, Cambridge (GB); Yan WU, Carlsbad, CA (US); Blazej Bogumil OSINSKI, Cambridge (GB)

(21) Appl. No.: 19/028,878

(22) Filed: Jan. 17, 2025

Related U.S. Application Data
(60) Provisional application No. 63/622,301, filed on Jan. 18, 2024.

(51) Int. Cl. G06N 20/00

(52) U.S. Cl. CPC G06N 20/00

(57) ABSTRACT

One or more embodiments include predicting, using one or more perturbation response models configured to take as input one or more basal states associated with one or more biological systems and a first plurality of perturbations, a first plurality of responses of the one or more biological systems to the first plurality of perturbations, predicting, using one or more cell state models configured to take as input the first plurality of responses, a first plurality of cell states associated with the first plurality of responses, wherein the one or more cell state models have been trained using a second plurality of training samples comprising observations of a plurality of biological systems paired with a second plurality of cell states, and selecting one or more additional perturbations included in the first plurality of perturbations for experimental evaluation based on the first plurality of cell states.

### CROSS-REFERENCE TO RELATED APPLICATIONS

This application claims priority benefit of united states provisional patent application titled “PERTURBATION RESPONSE AND TARGET CELL STATE MODELING,” Ser. No. 63/622,301, filed Jan. 18, 2024. The subject matter of this related application is hereby incorporated herein by reference.

### BACKGROUND

### Field of the Various Embodiments

Embodiments of the present disclosure relate generally to machine learning and, more specifically, to perturbation response and target cell state modeling.

### Description of the Related Art

Biological systems exhibit various complex phenomena that affect and/or reflect broader attributes such as health, aging, resilience, and/or responses to interventions or treatments. Recently, a variety of techniques have been developed to collect and analyze biological data for the purposes of understanding the rules or mechanisms that underly these phenomena and/or attributes. For example, imaging techniques such as Cryoelectron tomography (CryoET) can be used to produce high-resolution three-dimensional (3D) views of biological samples such as cells, tissues, organisms, or macromolecules. In another example, various “omics” disciplines can be used to study biological molecules that represent the structure, function, and dynamics of a biological system. Within these “omics” disciplines, genomics involves the study of the complete set of deoxyribonucleic acid (DNA) within a biological system (e.g., an organism), proteomics can be used to characterize proteins produced or modified by the biological system, transcriptomics involves the study of ribonucleic acid (RNA) molecules transcribed from the genome of a biological system, metabolomics can involves the study of small-molecule metabolites within a biological system, epigenomics involves the study of epigenetic modifications to the genetic material of a biological system, phenomics involves the study of observable characteristics or traits of a biological system, and metagenomics can be used to study genetic material recovered from environmental samples.

However, it can be difficult to determine or characterize patterns or relationships across large biological datasets that are generated using different techniques. More specifically, each type of biological data can provide a noisy and incomplete view of the state or functioning of a biological system. At the same time, physiological, functional, imaging, and/or other types of biological data can be difficult to relate to one another unless a single assay is used to collect these types of data from a single biological sample.

These difficulties in determining patterns and correlations across large biological datasets can further complicate the development and evaluation of interventions that provoke specific responses in biological systems. For example, interventions can include various genetic and/or chemical perturbations that are applied to cells, cell types, tissues, organs, and/or other biological systems. However, the responses of the biological systems to these perturbations can vary based on ages, disease states, injuries, genotypes, phenotypes, cell types (e.g., neurons vs fibroblasts), and/or other attributes associated with the biological systems. Additionally, combinations of perturbations are typically required to have an effect on the biological systems. Because there are billions to trillions of potential combinations, it would be infeasible to experimentally explore the responses of various biological systems to different combinations of perturbations.

As the foregoing illustrates, what is needed in the art are more effective techniques for analyzing and correlating data across different biological domains and interventions.

### SUMMARY

One or more embodiments include predicting, using one or more perturbation response models configured to take as input one or more basal states associated with one or more biological systems and a first plurality of perturbations, a first plurality of responses of the one or more biological systems to the first plurality of perturbations, wherein the one or more perturbation response models have been trained to reconstruct a first plurality of training samples, each of the first plurality of training samples comprising a basal state of a biological system, one or more covariates associated with the biological system, and one or more perturbations applied to the biological system, predicting, using one or more cell state models configured to take as input the first plurality of responses, a first plurality of cell states associated with the first plurality of responses, wherein the one or more cell state models have been trained using a second plurality of training samples comprising observations of a plurality of biological systems paired with a second plurality of cell states, and selecting one or more additional perturbations included in the first plurality of perturbations for experimental evaluation based on the first plurality of cell states.

One technical advantage of the disclosed techniques relative to the prior art is the ability to predict responses of different biological systems to various combinations of perturbations and predict cell states corresponding to the responses. The disclosed techniques can thus be used to identify perturbations that are likely to lead to improved biological ages, health states, phenotypes, and/or other target cell states without requiring time- and resource-intensive experiments to determine the effects of the perturbations on the biological systems. Another technical advantage of the disclosed techniques is the ability to focus limited computational and/or experimental resources on promising perturbations that are likely to result in the target cell states within the biological systems. Consequently, the disclosed techniques allow interventions that improve health and rejuvenation in the biological systems to be prioritized and verified in a targeted manner, thereby improving the exploration and understanding of biological rejuvenation across a large and complex search space of perturbations. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a more detailed illustration of the training engine and execution engine of FIG. 1, according to various embodiments.

FIG. 3 illustrates how the training engine of FIG. 1 trains a set of perturbation response models, according to various embodiments.

FIG. 4 illustrates how the training engine of FIG. 1 trains a set of cell state models, according to various embodiments.

FIG. 5 sets forth a flow diagram of method steps for performing perturbation response and target cell state modeling, according to various embodiments.

FIG. 6 illustrates an example architecture for a perturbation response model, according to various embodiments.

FIG. 7 shows a receiver operating characteristic (ROC) curve representing the performance of an example cell state model, in accordance with various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

As discussed above, it can be difficult to determine or characterize patterns or relationships across large biological datasets that are generated using different techniques. More specifically, each type of biological data can provide a noisy and incomplete view of the state or functioning of a biological system. At the same time, physiological, functional, imaging, and/or other types of biological data can be difficult to relate to one another unless a single assay is used to collect these types of data from a single biological sample.

These difficulties in determining patterns and correlations across large biological datasets can further complicate the development and evaluation of interventions that provoke specific responses in biological systems. For example, interventions can include hundreds or thousands of genetic and/or chemical perturbations to cells, cell types, tissues, organs, and/or other biological systems. However, the responses of the biological systems to these perturbations can vary based on the ages, cell types, disease states, injuries, genotypes, phenotypes, and/or other attributes associated with the biological systems. Consequently, it would be infeasible to experimentally evaluate the effects of various combinations of perturbations on all possible combinations of attributes associated with the biological systems.

To improve the understanding of patterns and relationships across biological datasets, the disclosed techniques train and execute various machine learning models to perform perturbation response and target cell state modeling. The machine learning models include one or more perturbation response learning models that are trained to predict responses of one or more biological systems to genetic, chemical, and/or other types of perturbations, based on input that includes vectors, encodings, and/or other representations of gene expression, basal states, covariates, and/or perturbations. For example, the perturbation response model(s) could include compositional perturbational autoencoders (CPAs) and/or other types of deep learning models with encoder-decoder architectures. Encoders in the perturbation response models could be used to generate embeddings representing the inputted basal states, cell types, perturbations, and/or covariates associated with the biological systems. Decoders in the perturbation response models could be used to decode the embeddings into gene expressions, images, proteins, and/or other output representing responses of the biological systems to the perturbations.

The machine learning models also include one or more cell state models that are trained to predict, from input that includes data collected from biological systems, health measure or attribute that represent measurable attributes indicative of health of the biological systems. For example, the cell state learning models could include nonlinear regression models, deep learning models, and/or other types of machine learning models that predict, based on gene expressions, images, proteins, and/or other data indicative of responses of biological systems to perturbations, biological ages, health or disease statuses, cell types, phenotypes, and/or other cell states corresponding to the representations.

After training is complete, the perturbation response and cell state models are integrated into a feedback loop of in silico and physical experiments to accelerate the discovery of interventions that are likely to improve health and/or rejuvenation in the biological systems. More specifically, the perturbation response model(s) can be used to explore perturbation responses across cell types, disease conditions, other basal states, covariates, modalities, perturbation types, perturbation combinations, and/or other variables. Perturbation responses generated by the perturbation response model(s) can then be inputted into the cell state model(s), and predictions of cell states generated by the cell state model(s) from the inputted perturbation responses can be used to identify a subset of perturbations that are likely to rejuvenate and/or otherwise improve the health of various types of cells. The identified perturbations can then be validated using various experimental screens, and results of the experimental screens can be used to retrain one or both sets of machine learning models (e.g., by providing ground truth data that is used to update the parameters of one or both sets of machine learning models).

### System Overview

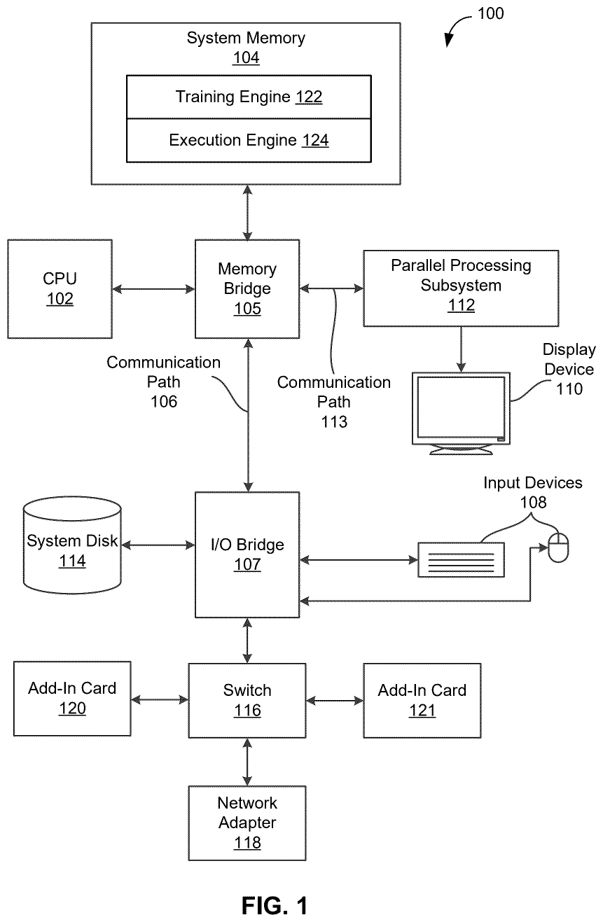

FIG. 1 is a block diagram illustrating a computer system 100 configured to implement one or more aspects of various embodiments. In one embodiment, computer system 100 includes a desktop computer, a laptop computer, a smart phone, a personal digital assistant (PDA), tablet computer, or any other type of computing device configured to receive input, process data, and optionally display images, and is suitable for practicing one or more embodiments. Computer system 100 also, or instead, includes a machine or processing node operating in a data center, cluster, or cloud computing environment that provides scalable computing resources (optionally as a service) over a network.

As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via the network adapter 118. In one embodiment, switch 116 is configured to provide connections between I/O bridge 107 and other components of the computer system 100, such as a network adapter 118 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

In some embodiments, parallel processing subsystem 112 includes a graphics subsystem that delivers pixels to an optional display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. Such circuitry may be incorporated across one or more parallel processing units (PPUs), also referred to herein as parallel processors, included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver configured to manage the processing operations of the one or more PPUs within parallel processing subsystem 112.

Parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. First, the functionality of the system can be distributed across multiple nodes of a distributed and/or cloud computing system. Second, the connection topology, including the number and arrangement of bridges, the number of CPUs 102, and the number of parallel processing subsystems 112, can be modified as desired. For example, in some embodiments, system memory 104 could be connected to CPU 102 directly rather than through memory bridge 105, and other devices would communicate with system memory 104 via memory bridge 105 and CPU 102. In another example, parallel processing subsystem 112 may be connected to I/O bridge 107 or directly to CPU 102, rather than to memory bridge 105. In a third example, I/O bridge 107 and memory bridge 105 may be integrated into a single chip instead of existing as one or more discrete devices. Third one or more components shown in FIG. 1 may not be present. For example, switch 116 could be eliminated, and network adapter 118 and add-in cards 120, 121 would connect directly to I/O bridge 107. Fourth, computer system 100 could be configured to execute any of the methods described herein.

In one or more embodiments, computer system 100 is configured to execute a training engine 122 and an execution engine 124 that reside in system memory 104. Training engine 122 and execution engine 124 may be stored in system disk 114 and/or other storage and loaded into system memory 104 when executed.

More specifically, training engine 122 and execution engine 124 include functionality to train and execute multiple types of machine learning models to perform perturbation response and target cell state modeling. Training engine 122 trains one or more perturbation response models to predict, from input that includes vectors, encodings, and/or other representations of gene expression, basal states, covariates, and/or perturbations associated with the biological system(s), responses of one or more biological systems (e.g., cell types, cell lines, tissues, organs, organisms, species, etc.) to genetic, chemical, and/or other types of perturbations. For example, the perturbation response model(s) could include compositional perturbational autoencoders (CPAs) and/or other types of deep learning models that generate embeddings representing basal states, cell types, perturbations, and/or covariates associated with the biological systems. The perturbation response model(s) could also be used to decode combinations of the embeddings into gene expressions, images (also referred to herein as “cell imaging data”), proteins, and/or other output representing responses of the biological systems to the perturbations. Thus, responses predicted by the perturbation response model(s) may include measurable and/or quantifiable changes to the corresponding biological systems after the perturbations have been applied to the biological systems.

Training engine 122 also trains one or more cell state models to predict cell states associated with biological systems. For example, the cell state model(s) could include nonlinear multivariate regression models, deep learning models, and/or other types of machine learning models that use inputted gene expressions, images, proteins, and/or other responses of biological systems to perturbations to predict biological ages, health or disease statuses, cell types, phenotypes, and/or other cell states corresponding to the representations. Each predicted cell state may include a measurable attribute that is indicative and/or representative of the health of a corresponding biological system.

After training is complete, execution engine 124 integrates the perturbation response and cell state models into a feedback loop of in-silico and physical experiments to accelerate discovery of promising hypotheses or interventions. More specifically, the perturbation response model(s) can be used to explore perturbation responses across cell types, disease conditions, basal states, covariates, modalities, perturbation types, perturbation combinations, and/or other variables. Perturbation responses generated by the perturbation response model(s) can then be inputted into the cell state model(s), and predictions of cell states generated by the cell state model(s) from the inputted perturbation responses can be used to identify a subset of perturbations that are likely to rejuvenate and/or otherwise improve the health or biological ages of various types of cells. The identified perturbations can then be validated using various experimental screens, and results of the experimental screens can be used to retrain one or more perturbation response models and/or one or more cell state models. The operation of training engine 122 and execution engine 124 is described in further detail below.

### Perturbation Response and Target Cell State Modeling

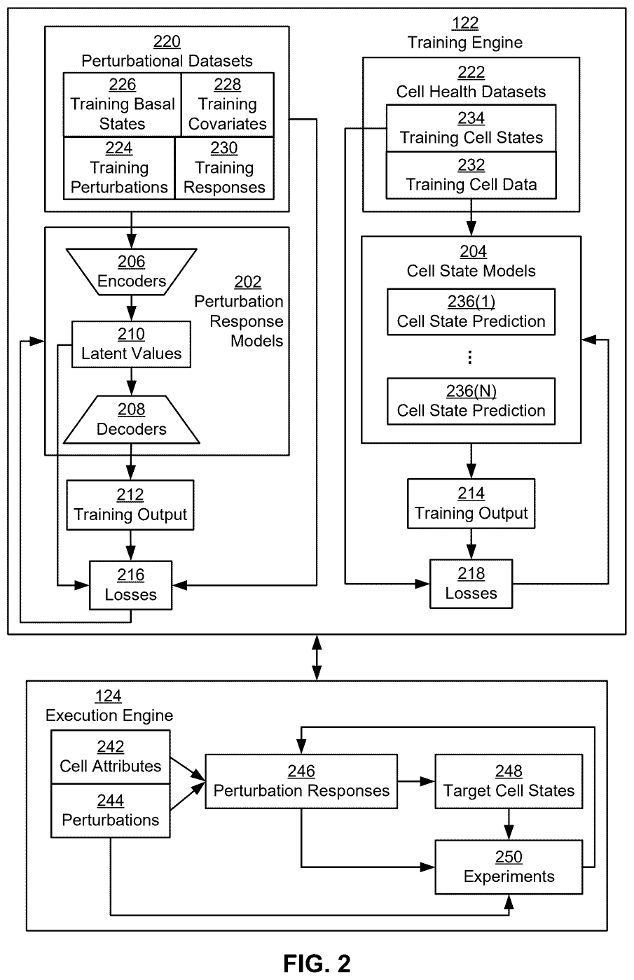

FIG. 2 is a more detailed illustration of training engine 122 and execution engine 124 of FIG. 1, according to various embodiments. As mentioned above, training engine 122 and execution engine 124 operate to train and execute multiple sets of machine learning models to perform perturbation response and target cell state modeling. As shown in FIG. 2, the machine learning models include one or more perturbation response models 202 and one or more cell state models 204.

Perturbation response models 202 include deep learning models that generate latent values 210 representing cell attributes 242 (e.g., basal states and covariates), perturbations 244, and/or other variables that affect biological age, health, and/or functioning of tissues, cell types, cell lines, and/or other types of biological systems. In some embodiments, latent values 210 correspond to embeddings of the variables in a lower-dimensional latent space. Perturbation response models 202 also use various combinations of latent values 210 to generate predictions of perturbation responses 246 represented by the combinations of the variables.

More specifically, perturbation response models 202 include one or more encoders 206 that decompose data representing perturbation responses 246 into different sets of latent values 210 corresponding to embeddings of cell types, perturbations, covariates, and/or other variables of interest. Perturbation response models 202 also include one or more decoders 208 that reconstruct perturbation responses 246 from combinations of embeddings representing the corresponding variables of interest. Decoders 208 could also, or instead, be trained to convert combinations of embeddings representing new combinations of these variables of interest into predictions of perturbation responses 246 associated with these variables of interest. For example, each of perturbation response models 202 could include a CPA, multi-modal CPA, ChemCPA, PerturbNet, variational autoencoder (VAE), Drug Response VAE (Dr.VAE), Geneformer, scGPT, and/or another type of deep learning model that uses one or more encoders 206 and one or more decoders 208 to generate latent values 210 associated with different perturbation responses 246 and convert combinations of the generated latent values 210 into predictions of new perturbation responses 246. Consequently, each of perturbation response models 202 is trained to learn a latent space representation of data representing different variables of interest, where latent values 210 in the latent space representation can be used to reconstruct individual variables of interest and/or combinations of variables of interest.

In one or more embodiments, training engine 122 trains perturbation response models 202 using one or more perturbational datasets 220. As shown in FIG. 2, perturbational datasets 220 include training basal states 226, training covariates 228, training perturbations 224, and training responses 230 associated with one or more biological systems. Training basal states 226 correspond to observed, measured, and/or inferred states of the biological systems before training perturbations 224 are applied to the biological systems (or, alternatively, in the absence of training perturbations 224). For example, training basal states 226 could include information indicative of gene expressions, images, proteins, and/or other quantifiable states of the biological systems prior to exposing the biological systems to training perturbations 224.

Training perturbations 224 include various types of interventions that can be applied to the biological systems. For example, training perturbations 224 could include information indicative of drugs, genetic perturbations, procedures, and/or other types of controlled events that are capable of effecting changes to the biological systems.

Training covariates 228 include variables that influence outcomes associated with applying training perturbations 224 to biological systems with the corresponding training basal states 226. For example, training covariates 228 could include doses, times, and/or other variables related to the application of training perturbations 224 to the biological systems. Training covariates 228 could also, or instead, include information indicative of cell types, cell lines, disease states, phenotypes, species, patients, ages, and/or other variables associated with the biological systems to which training perturbations 224 are applied.

Training responses 230 include observed, measured, and/or inferred states of the biological systems after training perturbations 224 are applied to the biological systems. For example, training responses 230 could include information indicative of gene expressions, images, proteins, and/or other representations of the biological systems after the biological systems have been exposed to genetic, chemical, and/or other types of perturbations.

During training of perturbation response models 202, training engine 122 inputs observed data representing training responses 230 of the biological systems into encoders 206. Encoders 206 generate latent values 210 representing estimates of training basal states 226, training covariates 228, and training perturbations 224 associated with these training responses 230, and decoders 208 convert the generated latent values 210 into training output 212 that includes reconstructions of training responses 230. Training engine 122 computes one or more losses 216 from latent values 210, training output 212, and/or data in perturbational datasets 220. Training engine 122 also uses a training technique (e.g., gradient descent and backpropagation) to update parameters of encoders 206 and decoders 208 within perturbation response models 202 in a way that reduces losses 216.

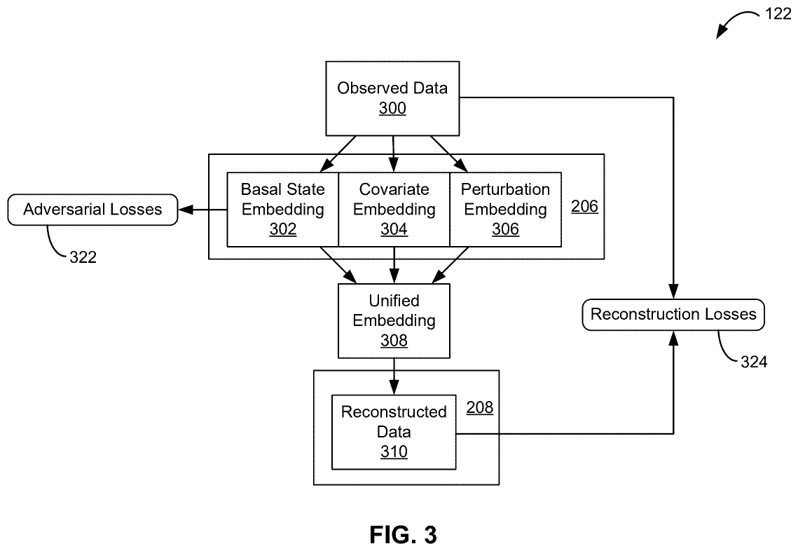

FIG. 3 illustrates how training engine 122 of FIG. 1 trains a set of perturbation response models 202, according to various embodiments. As shown in FIG. 3, training engine 122 inputs observed data 300 into one or more encoders 206 included in perturbation response models 202. For example, training engine 122 could input a gene expression, image, set of proteins, and/or other observed data 300 from a given biological system into encoders 206.

Training engine 122 uses encoders 206 to convert a training sample that includes observed data 300 into one or more latent values 210 that include a basal state embedding 302, a covariate embedding 304, and/or a perturbation embedding 306. Basal state embedding 302 represents a basal state (e.g., in training basal states 226) of the biological system, covariate embedding 304 represents one or more training covariates 228 associated with the biological system, and perturbation embedding 306 represents one or more training perturbations 224 applied to the biological system.

Training engine 122 combines basal state embedding 302, covariate embedding 304, and perturbation embedding 306 into a unified embedding 308. For example, training engine 122 could compute unified embedding 308 as a sum and/or another aggregation of basal state embedding 302, covariate embedding 304, and perturbation embedding 306.

Training engine 122 also inputs unified embedding 308 into one or more decoders 208 included in perturbation response models 202 and uses decoders 208 to convert unified embedding 308 into reconstructed data 310 that corresponds to a reconstruction of observed data 300. For example, training engine 122 could use decoders 208 to generate a gene expression, protein data, image, and/or another reconstruction of the inputted observed data 300.

Training engine 122 also trains encoders 206 and decoders 208 using reconstruction losses 324 computed between observed data 300 and reconstructed data 310. For example, training engine 122 could compute reconstruction losses 324 as one or more Gaussian negative log-likelihoods, negative binomial losses, Kullback-Leibler (KL) divergences, and/or other measures of error between representations of observed data 300 and corresponding representations of reconstructed data 310. Training engine 122 could also update parameters of encoders 206 that generate basal state embedding 302, covariate embedding 304, and perturbation embedding 306 and decoders 208 that convert unified embedding 308 into reconstructed data 310 using a weighted combination of the computed reconstruction losses 324 and adversarial losses 322.

In some embodiments, training engine 122 also trains encoders 206 and decoders 208 using a set of adversarial losses 322. More specifically, training engine 122 can train one or more encoders 206 that generate basal state embedding 302 and one or more discriminator neural networks (not shown) in an adversarial fashion. During this adversarial training, a given encoder learns to generate basal state embedding 302 that represents the basal state of a biological system and cannot be used by the discriminator neural network(s) to predict the perturbation or covariate values. For example, training engine 122 could perform adversarial training of encoders 206 and the discriminator neural networks by inputting, into the encoder, a gene expression and/or another representation of basal state and using the encoder to encode the inputted representation into a corresponding basal state embedding 302. To ensure that information about covariate and perturbation values is removed from basal state embedding 302, training engine 122 alternates between two training steps that separately train the discriminator neural network(s) and encoders 206 and decoders 208 in perturbation response models 202. During the first training step, training engine 122 trains the discriminator neural network(s) using cross entropy losses and/or other adversarial losses 322 that are computed between predictions of perturbations and covariates generated by the discriminator neural network(s) from basal state embedding 302 and training perturbations 224 and training covariates 228 associated with the corresponding observed data 300. During the second training step, training engine 122 trains encoders 206 and decoders 208 using a combined loss that includes a reconstruction loss computed between reconstructed data 310 and the corresponding observed data 300 and the cross-entropy losses.

Consequently, adversarial losses 322 allow encoders 206 to learn a latent space that disentangles the basal state of a biological system from perturbations and covariates associated with the biological system. At the same time, reconstruction losses 324 are used to train encoders 206 and decoders 208 to reconstruct a given set of observed data 300 from a corresponding basal state embedding 302, covariate embedding 304, and perturbation embedding 306 in the latent space. After encoders 206 and decoders 208 have been trained in this manner, encoders 206 and decoders 208 can be used to predict additional responses of the biological systems to new combinations of perturbations, as discussed in further detail below.

Returning to the discussion of FIG. 2, cell state models 204 include multilayer perceptrons (MLPs), deep learning models, and/or other types of machine learning models that convert perturbation responses 246 outputted by perturbation response models 202 into cell states 248 representing the corresponding perturbed biological systems. More specifically, cell state models 204 include one or more classifiers and/or regression models that generate cell state predictions 236(1)-236(N) (each of which is referred to individually herein as cell state prediction 236) representing a cell state associated with a biological system, given input that includes data representing the response of the biological system to a combination of perturbations 224. These cell state predictions 236 can include (but are not limited to) scores and/or other numeric values representing biological age, health status, disease status, phenotype, cell type prevalence, and/or other measurable, observable, and/or quantifiable attributes related to the health or functioning of the biological system.

In one or more embodiments, training engine 122 trains cell state models 204 using one or more cell health datasets 222. As shown in FIG. 2, cell health datasets 222 include training cell states 234 and training cell data 232 associated with one or more biological systems. Cell states 248 include various measurable “attributes of interest” associated with related to the health or functioning of the biological systems. For example, cell states 248 could include biological ages for example transcriptomic age, or chronological age and/or, predictions of probabilities and/or magnitudes related to health or disease statuses, disease progressions, cell types, phenotypes, and/or other attributes that can be used to characterize the overall state or health of the biological systems such as energy metabolism of cells e.g. by measuring mitochondrial function, and/or biological function of cells e.g. for fibroblasts measuring fibroblast migration.

Training cell data 232 corresponds to observations of the biological system(s). For example, training cell data 232 could include transcriptomic data (which can also be referred to herein as gene expressions), images, protein expressions, and/or other information indicative of measurable attributes of interest of the biological system(s).

During training of cell state models 204, training engine 122 inputs training cell data 232 for the biological system(s) into cell state models 204. Training engine 122 executes cell state models 204 to convert the inputted training cell data 232 into cell state predictions 236 for the biological system(s). Training engine 122 uses individual cell state predictions 236 and/or combinations of cell state predictions 236 as training output 214 of cell state models 204. Training engine 122 computes one or more losses 218 from training output 214 and the corresponding “ground truth” training cell states 234 in cell health datasets 222. Training engine 122 additionally uses a training technique (e.g., gradient descent and backpropagation) to update parameters of cell state models 204 in a way that reduces losses 218.

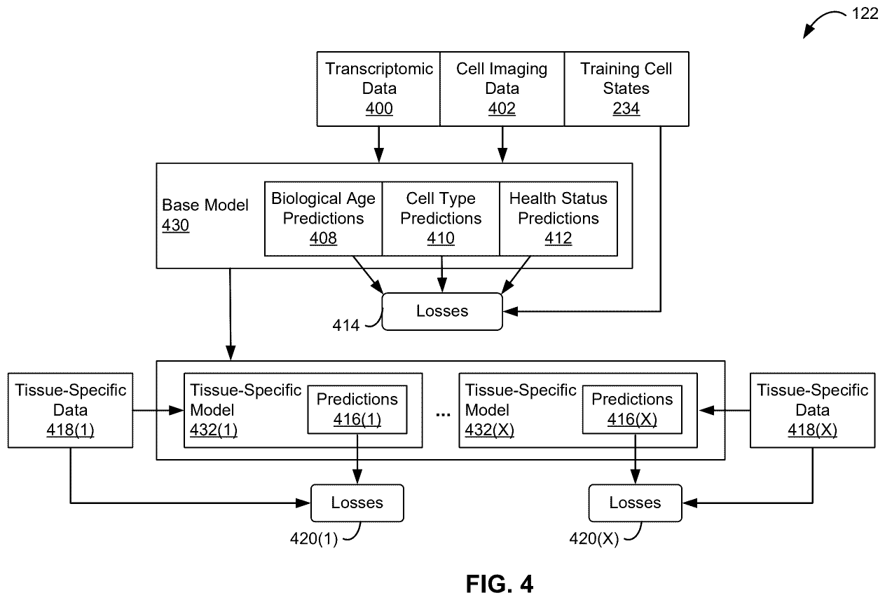

FIG. 4 illustrates how training engine 122 of FIG. 1 trains a set of cell state models 204, according to various embodiments. As shown in FIG. 4, cell state models 204 include a base model 430 and a number of tissue-specific models 432(1)-432 (X) (each of which is referred to individually herein as tissue-specific model 432).

Training engine 122 initially trains base model 430 to generate biological age predictions 408, cell type predictions 410, and health status predictions 412 from input that includes transcriptomic data 400 (including but not limited to gene expressions) and cell imaging data 402 for multiple tissue types. Transcriptomic data 400 and cell imaging data 402 can be included in training cell data 232 from one or more cell health datasets 222.

Transcriptomic data 400 includes observed gene expressions of one or more biological system(s). For example, transcriptomic data 400 could include ribonucleic acid (RNA) transcripts of cells, cell lines, tissues, organisms, and/or other biological systems. These RNA transcripts could be generated via microarrays, RNA sequencing techniques, and/or other techniques.

Cell imaging data 402 includes images of the biological system(s). For example, cell imaging data 402 could include brightfield images, stained cell images, and/or other types of images of the biological system(s) that are captured using optical and/or other microscopy techniques.

More specifically, training engine 122 inputs transcriptomic data 400 and/or cell imaging data 402 for multiple tissue types into base model 430. Training engine 122 uses base model 430 to generate biological age predictions 408 that include numeric values representing the biological ages of the corresponding biological systems. Training engine 122 also, or instead, uses base model 430 to generate cell type predictions 410 that include scores and/or other output representing the likelihood or prevalence of a given cell type in the biological systems. Training engine 122 also, or instead, uses base model 430 to generate health status predictions 412 that include scores and/or other output characterizing a probability, level, progression, and/or another measure related to a specific health or disease attribute in the biological systems.

Training engine 122 computes a first set of losses 414 between biological age predictions 408, cell type predictions 410, and/or health status predictions 412 generated by base model 430 and the corresponding training cell states 234 in the cell health dataset(s). For example, training engine 122 could compute losses 414 as a mean squared error (MSE), mean absolute error (MAE), Huber loss, quantile loss, and/or another measure of error between predictions generated by base model 430 and the corresponding ground truth training cell states 234.

Training engine 122 also updates parameters of base model 430 in a way that reduces the computed losses 414. For example, training engine 122 could train base model 430 using losses 414 until one or more conditions are met. These condition(s) include (but are not limited to) convergence in the parameters of base model 430, the lowering of losses 414 to below a threshold, and/or a certain number of training steps, iterations, batches, and/or epochs.

After training of base model 430 is complete, training engine 122 uses the trained base model 430 as a starting point for training additional tissue-specific models 432. For example, training engine 122 could initialize each tissue-specific model 432 using the parameters of the trained base model 430.

As shown in FIG. 4, training engine 122 uses a different set of tissue-specific data 418(1)-418(X) (each of which is referred to individually herein as tissue-specific data 418) to train a corresponding tissue-specific model 432. In some embodiments, each set of tissue-specific data 418 includes transcriptomic data 400, cell imaging data 402, and/or training cell states 234 for a different type of tissue, such as (but are not limited to) kidney cells, endothelial cells, fibroblasts, neural cells, muscle cells, and/or other types of tissues of interest.

In one or more embodiments, training engine 122 adapts or fine-tunes each tissue-specific model 432 to generate biological age predictions 408, cell type predictions 410, and/or health status predictions 412 for a corresponding type of tissue. More specifically, training engine 122 inputs transcriptomic data 400, cell imaging data 402, and/or other observed training cell data 232 included in a set of tissue-specific data into a different tissue-specific model 432. Training engine 122 uses tissue-specific models 432 to generate predictions 416(1)-416(X) (each of which is referred to individually herein as predictions 416) of biological age, cell type, health status, and/or other attributes from the inputted tissue-specific data 418. For each tissue-specific model 432, training engine 122 computes one or more losses 420(1)-420(X) (each of which is referred to individually herein as losses 420) as an MSE, MAE, Huber loss, quantile loss, and/or another measure of error between predictions 416 outputted by that tissue-specific model 432 and the corresponding ground truth training cell states 234 in tissue-specific data 418 associated with that tissue-specific model 432.

Training engine 122 then updates parameters of each tissue-specific model 432 in a way that reduces the computed losses 420. For example, training engine 122 could train tissue-specific models 432 using the corresponding losses 420 until one or more conditions are met. These condition(s) include (but are not limited to) convergence in the parameters of a given tissue-specific model 432, the lowering of losses 420 for that tissue-specific model 432 to below a threshold, and/or a certain number of training steps, iterations, batches, and/or epochs.

By training base model 430 to generate biological age predictions 408, cell type predictions 410, and/or health status predictions 412 for multiple types of tissues and/or biological systems, training engine 122 generates a multi-tissue model of biological age, health, cell type, and/or other training cell states 234. Training engine 122 can then train additional tissue-specific models 432 to better understand aging, rejuvenation, health, and/or disease in the corresponding types of tissues. As discussed in further detail below, the trained base model 430 and/or tissue-specific models 432 can then be used to predict cell states 248 associated with perturbation responses 246 generated by perturbation response models 202 from latent values 210 representing new combinations of basal states, covariates, and perturbations in biological systems.

Returning to the discussion of FIG. 2, after training engine 122 has trained a set of perturbation response models 202 and a set of cell state models 204, in some embodiments, execution engine 124 uses one or more trained perturbation response models 202 and trained cell state models 204 in a feedback loop of in-silico and physical experiments 250 to accelerate discovery of promising hypotheses or interventions. More specifically, execution engine 124 uses one or more perturbation response models 202 to convert different combinations of cell attributes 242 (e.g., cell types, cell lines, disease conditions, basal states, covariates, modalities, etc.) and perturbations 244 into corresponding predict perturbation responses 246. For example, execution engine 124 could use a perturbation response model associated with a specific modality, set of modalities, and/or biological system to convert different combinations of cell attributes 242 and perturbations 244 into perturbation responses 246. As used herein, “modality” refers to a type of data, such as (but not limited to) text data, image data, audio data, transcriptomic data, and/or other data that represents observations and/or characterizations of one or more cells.

To reduce the resource overhead associated with generating perturbation responses 246, execution engine 124 may determine and/or filter the combinations of cell attributes 242 and perturbations 244 using expert knowledge, existing studies, genome editing libraries, and/or other sources of data related to perturbation of biological systems. For example, execution engine 124 may retrieve, from the sources of data, specific perturbations 244 and cell attributes 242 of cells to which those perturbations 244 are applied that lead to restoration of cell health and/or other outcomes of interest.

Execution engine 124 also uses one or more cell state models 204 identify perturbation responses 246 that result in target cell states 248 for the corresponding biological systems. In some embodiments, target cell states 248 represent healthy, rejuvenated, and/or other “desired” cell states of the biological systems. For example, target cell states 248 could include a target biological age, health score, cell type score, phenotype, and/or another value associated with the output of cell state models 204.

To determine perturbation responses 246 that correspond to target cell states 248, execution engine 124 inputs perturbation responses 246 into one or more cell state models 204. Execution engine 124 uses the cell state model(s) to predict, based on the inputted perturbation responses 246, predictions of biological age, health, cell types, and/or other cell states for the biological systems. Execution engine 124 also identifies perturbation responses 246 with predicted cell states that correspond to target cell states 248. For example, execution engine 124 could identify a subset of perturbation responses 246 with biological ages, health scores, cell type scores, and/or other predicted cell states that fall within values or ranges of values that correspond to target cell states 248. In another example, execution engine 124 could aggregate (e.g., using a sum, weighted sum, average, etc.) biological ages, health scores, cell type scores, and/or other predicted cell states generated by cell state models 204 into overall scores for the corresponding perturbation responses 246. Execution engine 124 could rank perturbation responses 246 by the overall scores and use the ranking to select a subset of perturbation responses 246 with the best overall scores. In both examples, perturbation responses 246 identified by execution engine 124 could represent perturbations that are likely to rejuvenate and/or otherwise improve the health or biological ages of various types of cells.

Execution engine 124 additionally uses one or more experiments 250 to validate the effects of the perturbations on the biological systems. For example, execution engine 124 could generate output that includes a list of cell attributes 242, perturbations 244, and perturbation responses 246 associated with target cell states 248. This output could be used to conduct one or more physical experiments 250 to determine whether or not perturbations 244 applied to biological systems with cell attributes 242 result in the predicted perturbation responses 246. Experiments 250 could also, or instead, be used to determine whether or not the responses of the biological systems to perturbations 244 result in target cell states 248.

Execution engine 124 can additionally provide results of experiments 250 to training engine 122, and training engine 122 can use the results to retrain one or more perturbation response models 202 and/or one or more cell state models 204. For example, execution engine 124 could add basal states, covariates, perturbations, and observed responses to the perturbations from experiments 250 to one or more new perturbational datasets 220. Execution engine 124 could provide the new perturbational datasets 220 to training engine 122, and training engine 122 could use the new perturbational datasets 220 to retrain one or more existing perturbation response models 202 and/or train one or more new perturbation response models 202. In another example, execution engine 124 could populate one or more new cell health datasets 222 with training cell data 232 that includes observed responses to perturbations 244 from experiments 250 and training cell states 234 that include biological ages, health scores, cell type scores, and/or other attributes associated with the observed responses to perturbations 244. Execution engine 124 could provide the new cell health datasets 222 to training engine 122, and training engine 122 could use the new cell health datasets 222 to retrain one or more existing cell state models 204 and/or train one or more new cell state models 204.

Training engine 122 and execution engine 124 can continue training or retraining perturbation response models 202 and cell state models 204, using the trained or retrained perturbation response models 202 and cell state models 204 to predict perturbation responses 246 and cell states associated with various combinations of cell attributes 242 and perturbations 244, identifying perturbation responses 246 that correspond to target cell states 248, and performing experiments 250 to validate perturbation responses 246 and/or target cell states 248 associated with perturbations 244 of the corresponding biological systems. In repeating this cycle, training engine 122 and execution engine 124 can generate more accurate perturbation response models 202 and cell state models 204 for various biological systems and identify additional perturbation responses 246 and corresponding perturbations 244 that lead to target cell states 248 in the biological systems. Consequently, training engine 122 and execution engine 124 include functionality to improve the understanding of biological systems and rejuvenation in the biological systems over time.

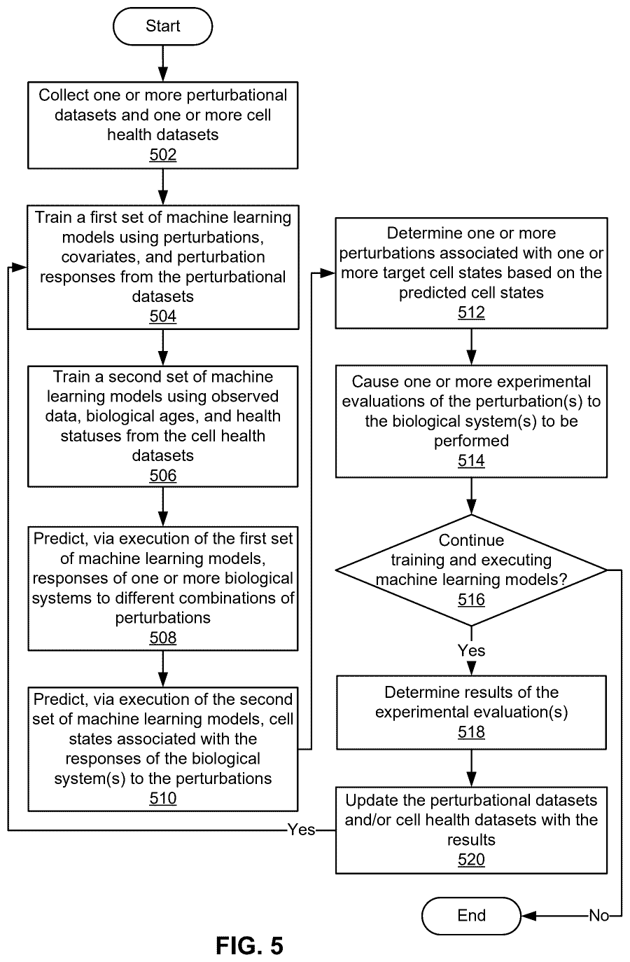

FIG. 5 sets forth a flow diagram of method steps for performing perturbation response and target cell state modeling, according to various embodiments. Although the method steps are described in conjunction with the systems of FIGS. 1-4, persons skilled in the art will understand that any system configured to perform some or all of the method steps in any order falls within the scope of the present disclosure.

As shown, in step 502, training engine 122 collects one or more perturbational datasets and one or more cell health datasets. For example, training engine 122 could generate the perturbational datasets and/or cell health datasets from experimental results, public datasets, and/or other datasets that include responses of biological systems to perturbations and/or cell states associated with the biological systems.

In step 504, training engine 122 trains a first set of machine learning models using perturbations, covariates, and perturbation responses from the perturbational datasets. For example, training engine 122 could train one or more encoders in the first set of machine learning models to convert observed data representing responses of biological systems to perturbations into latent values representing basal states, covariates, and perturbations. Training engine 122 could also train one or more decoders in the first set of machine learning models to convert combinations of the latent values into reconstructions of the corresponding responses to perturbations by the biological systems.

In step 506, training engine 122 trains a second set of machine learning models using observed data, biological ages, and health statuses from the cell health datasets. For example, training engine 122 could train one or more nonlinear multivariate regression models to predict biological ages, health scores, and/or cell type scores for various biological systems from gene expressions, images, and/or other representations of the biological systems. The nonlinear multivariate regression models could include a base model that is trained to predict cell states for different types of tissues. After training of the base model is complete, the base model could be used to initialize multiple tissue-specific models. Each tissue-specific model could then be fine-tuned using a different tissue-specific dataset to generate cell state predictions for a corresponding type of tissue.

In step 508, execution engine 124 predicts, via execution of the first set of machine learning models, responses of one or more biological systems to different combinations of perturbations. For example, execution engine 124 could use one or more encoders in the first set of machine learning models to generate embeddings of basal states, covariates, and perturbations associated with the biological system(s). Execution engine 124 could combine (e.g., sum, average, aggregate, concatenate, etc.) the basal state, covariate, and perturbation embeddings into unified embeddings representing the corresponding combinations of basal states, covariates, and perturbations in the biological system(s). Execution engine 124 could then use one or more decoders in the first set of machine learning models to convert the unified embeddings into gene expressions, proteins, images, and/or other representations of the responses of the biological system(s) to the perturbations.

In step 510, execution engine 124 predicts, via execution of the second set of machine learning models, cell states associated with the responses of the biological system(s) to the perturbations. For example, execution engine 124 could input one or more gene expressions, images, and/or other data representing a predicted response of a biological system to a perturbation into a regression model included in the second set of machine learning models. Execution engine 124 could use the regression model to convert the data into a biological age, health score, cell type score, and/or another representation of cell state for the biological system.

In step 512, execution engine 124 determines one or more perturbations associated with one or more target cell states based on the predicted cell states. For example, execution engine 124 could aggregate the predicted biological age, health score, cell type score, and/or another representation of cell state for each biological system into an overall score for the biological system. Execution engine 124 could rank the responses of the biological systems to various perturbations by the corresponding overall scores. Execution engine 124 could then select a subset of perturbations that result in the highest or best overall scores (e.g., as a predefined number of highest ranked perturbations, a variable number of perturbations with overall scores that meet or exceed a threshold, etc.). In another example, execution engine 124 could identify a subset of perturbations that result in predicted biological ages, health scores, cell type scores, and/or other representations of cell states that correspond to one or more predefined target cell states.

In step 514, execution engine 124 causes one or more experimental evaluations of the perturbation(s) to the biological system(s) to be performed. For example, execution engine 124 could generate output that includes basal states, covariates, perturbations, responses to perturbations, predicted cell states, and/or other attributes associated with the perturbations identified in step 512. This output could be used to conduct experiments that validate the responses of the biological system(s) to the perturbations, the cell states represented by the responses, and/or other predictions generated by the first and/or second sets of machine learning models.

In step 516, training engine 122 and/or execution engine 124 determine whether or not to continue training and executing the machine learning models. For example, training engine 122 and/or execution engine 124 could continue training and executing the machine learning models in a feedback loop of in silico and physical experiments to better understand biology and rejuvenation in the biological system(s). If training engine 122 and/or execution engine 124 determine that training and execution of the machine learning models should not continue, no additional processing is performed using the machine learning models.

If training engine 122 and/or execution engine 124 determine that the machine learning models should continue to be trained and executed, execution engine 124 performs step 518, in which execution engine 124 determines results of the experimental evaluation(s). For example, execution engine 124 could determine perturbation responses, cell states, and/or other results associated with experiments that involve applying perturbations identified in step 512 to the biological system(s). In step 520, execution engine 124 updates the perturbational datasets and/or cell health datasets with the results. For example, execution engine 124 could populate one or more new perturbational datasets and/or cell health datasets with the results. Execution engine 124 could also, or instead, add the results to one or more existing perturbational datasets and/or cell health datasets.

After the perturbational datasets and/or cell health datasets have been updated with results of the experiments, training engine 122 and execution engine 124 repeat steps 504, 506, 508, 510, 512, 514, and 516 to train and/or retrain the first and second sets of machine learning models using the updated perturbational datasets and/or cell health datasets; use the updated machine learning models to identify additional perturbations have the potential to improve cell health, biological age, and/or other cell states in the biological system(s); and experimentally validate the effect of the perturbations on the cell states of the biological system(s). Training engine 122 and execution engine 124 can thus continue the feedback loop of in silico and physical experiments to improve the understanding of biology and rejuvenation in the biological system(s) while the machine learning models are used in the feedback loop.

### Example Implementations

The following is presented by way of example and is not to be construed as limiting the scope of the claims or disclosed embodiments.

### Example Perturbation Response Model

The following describes an example perturbation response model that predicts the expression profile of a cell after being perturbed by a genetic or chemical intervention. In this example, the perturbation response model operates by transforming input data into a lower-dimensional, meaningful latent representation that can be subsequently used for various regression and/or classification tasks.

This example perturbation response model can be applied to any perturbational dataset with transcriptomic readouts. One specific example dataset is a CRISPR-Cas9 knockout screen performed in patient derived melanoma cells in 3 different culture conditions. Specifically, the Frangieh21 dataset includes 248 immune checkpoint response related genes in melanoma cells cultured in 3 different biological conditions that have been knocked out. The conditions are melanoma cells 1) alone, 2) stimulated by interferon gamma (IFNg), and 3) co-cultured with tumor infiltrating leukocytes, which are referred to as the 1) none, 2) IFNg, and 3) co-culture conditions herein. These co-culture conditions are an example of a covariate-defined as a data attribute that is not a perturbation but is a data attribute of which the perturbation response model should have knowledge. A dataset may include multiple covariates (e.g., both cell type and culture condition), but this dataset includes only one type of covariate. The Frangieh21 dataset also includes measured gene expression responses using single cell RNA sequencing, resulting in profiling of the gene expression of 218,331 single cells, where each cell is an individual data point.

The Frangieh21 dataset is divided into training, validation, and test splits on a per-perturbation and per-covariate basis, where all cells belonging to a given perturbation in a given covariate are assigned to the same split. The training split included all perturbations in the none and IFNg covariates and 74 perturbations in the co-culture covariate. 87 perturbations in the co-culture covariate were held out for the validation split, and another 87 perturbations in the co-culture covariate were held out for the test split. This split is meant to simulate a scenario where perturbations in simpler biological conditions (none & IFNg) have been measured and used to predict perturbation effects in a more complex biological condition (co-culture).

The Frangieh21 dataset is preprocessed in the following manner:
1. Subsetting Relevant Genes: Genes that are either highly variable or differentially expressed are selected. The top 4000 genes are retained using the scanpy.pp.highly_variable_genes function with the ‘seurat_v3’ selection method. The top 25 differentially expressed genes are also retained using the scanpy.tl.rank_genes_groups method with default parameters for every perturbation in every unique set of covariates. The perturbed genes are additionally selected.
2. Normalization: To enable comparison across cells, total counts normalization is applied, which involves scaling the raw counts based on total counts per cell and multiplying by a scaling factor of 10,000. The normalized expression values are then stabilized using a log-transform, adding a pseudocount of one to avoid taking the log of zero.

For the Frangieh21 example dataset, the preprocessing results in a dataset with normalized gene expression values for 9,140 genes, which are the dataset features. The number of data points is unchanged.

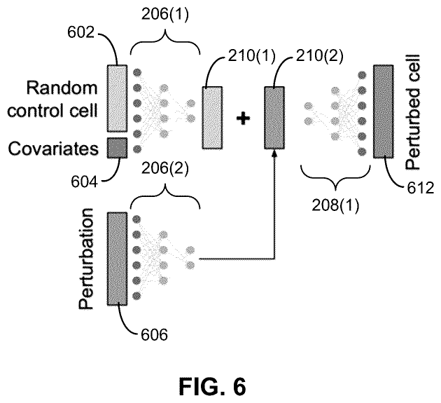

FIG. 6 illustrates an example architecture for a perturbation response model, according to various embodiments. More specifically, FIG. 6 illustrates an example architecture for a perturbation response model that is trained to predict the expression profile of a cell after being perturbed by a genetic or chemical intervention, as discussed herein with respect to this example.

As shown in FIG. 6, the perturbation response model includes two encoders 206(1) and 206(2) and one decoder 208(1). Input into encoder 206(1) includes a vector 602 of gene expression from a randomly sampled control cell, or an average of multiple sampled control cells, that have been normalized and log-transformed as described in the preprocessing section, xᵢ. The length is equal to the number of genes in the dataset, which is 9,140 for the Frangieh19 dataset.

Input into encoder 206(1) also includes one or more covariates (cell type, treatment, batch, etc.) represented as a concatenated vector 604 of one-hot encodings of each covariate, where vector 604 has a length equal to the number of unique covariates, cᵢ. For example, in the Frangieh21 dataset, the covariate representation would look like [1,0,0] for the none condition, [0,1,0] for the IFNg condition, and [0,0,1] for the co-culture condition.

Input into encoder 206(2) includes a perturbation response represented as a multi-hot encoding vector 606 with length equal to the number of unique perturbations, pᵢ. For example, if a cell has received perturbation 1 out of 5, the representation would be [1,0,0,0,0]. If a cell received both perturbation 1 and perturbation 3, the representation would be [1,0,1,0,0]. For the Frangieh21 dataset, this vector 606 has length of 248, which corresponds to the total number of unique perturbations not including the control perturbation.

Encoder 206(1) is used to map vectors 602 and 604 to a first set of latent values 210(1) in the latent space associated with the perturbation response model. Encoder 206(2) is used to map vector 602 to a second set of latent values 210(2) in the latent space. Encoders 206(1) and 206(2) can be implemented as MLPs with dropout to prevent overfitting and layer normalization to improve convergence and generalization. However, any type of encoder can be used, including but not limited to transformer neural networks. The encoder width is a hyperparameter ranging from 1024-8192 neurons and is set to 2304 neurons for all encoders in the Frangieh21 dataset. The number of hidden encoder layers (not including the input layer) is a hyperparameter ranging from 1-7 layers and is set to 1 layer for all encoders in the Frangieh21 dataset. ReLu activations are used, and the dropout is a hyperparameter between 0.0-0.7 that is set to 0.3 for the Frangieh21 dataset.

Consequently, the operation of encoder 206(1) is represented by z_{x,i}=fₓ(xᵢ, cᵢ), or an encoding function that maps the control cell gene expression and covariates into the latent space. The operation of encoder 206(2) is represented by z_{p,i}=fₚ(pᵢ), or an encoding function for the perturbation data that results in a perturbation-specific latent representation.

Once in the latent space, the perturbation response model conditions the latent control cell representation with the perturbation representation by adding the two sets of latent values 210(1) and 210(2): zᵢ=z_{x,i}+z_{p,i}. For the Frangieh21 dataset, a latent dimension of size 256 is used. Concatenation, cross-attention, and/or other conditioning mechanisms can also be used to combine latent values 210(1) and 210(2).

The resultant latent representation zᵢ, is translated back into gene expression space by decoder 208(1) to predict the gene expression of the perturbed cell, xᵢ′, through the decoding function: xᵢ′=g(zᵢ). This function currently has the same implementation including the same number of layers and width as the encoder MLPs except for the addition of a softplus layer at the end to ensure nonnegative outputs.

By operating in the latent space where gene expression, covariates, and perturbations are first encoded into a latent representation before being combined and transformed back into the original space, the perturbation response model can capture nonlinear interactions within the data, providing an expressive and powerful approach for predicting the effects of perturbations on gene expression.

Training of the perturbation response model involves iterating over perturbed cells one batch of cells at time, with the batch size varying depending on the dataset and available compute. For the Frangieh21 dataset, a batch size of 8000 cells was used.

For every perturbed cell, one or more control cells are sampled from the set of control cells with the same covariates (cell type, treatment, batch, etc.) as the perturbed cell and average their gene expression. Using the Frangieh21 dataset as an example, for a given perturbed cell, control cells would be sampled from a pool of control cells sharing the same culture condition (none, IFNg, co-culture). If 5 cells were sampled, that would result in 5 vectors of length 9,140 (the number of genes/features) that are concatenated into a matrix of dimension 5×9,140. An average over the rows of the matrix is performed to create an averaged control vector of length 9,140. The number of control cells sampled is a tunable hyperparameter ranging from 1-75 cells, and a single cell was sampled for the Frangieh21 dataset.

The example perturbation response model was trained using a mean squared error (MSE) between the predicted and observed gene expression for the perturbed cell across all genes in the dataset as our loss function, which can be formally written as:

$$M S E = \frac{1}{n} {\sum }_{i = 0}^{n - 1} {( {y}_{i} - \hat{{y}_{ι}} )}^{2}$$

Where n is the number of genes (9,140 for the Frangieh21 dataset), γᵢ is the observed expression of the perturbed cell for gene i, and γᵢ is the predicted expression for gene i. For a given batch of data, an MSE is computed for every cell in the batch, and MSEs for multiple cells in a given batch are averaged to get a loss that is fed back into the optimizer for that given gradient step.

The perturbation response model was also trained using a preset maximum and minimum number of epochs, where each epoch refers to iterating through the entire dataset one time. For the example perturbation response model trained on the Frangieh21 dataset, the minimum number of epochs is set to 5, and the maximum number of epochs is set to 400. Early stopping that monitors the validation loss (defined by the average MSE over all batches in the validation split) for each epoch is also used. If the validation loss does not decrease after 50 consecutive epochs, training of the perturbation response model is discontinued before the maximum number of epochs. Once training of the perturbation response model is stopped, the model weights from the epoch with the minimum validation loss is loaded.

An Adam optimizer implemented in PyTorch was used to train the perturbation response model. This optimizer used default parameters except for the weight decay and learning rate, both of which are hyperparameters. For the Frangieh21 dataset, the learning rate was set to 0.0000523, and the weight decay was set to 1.56×10⁻⁰⁷. The perturbation response model can use many different learning rate schedulers, including a cosine learning rate scheduler and a scheduler that reduces the learning rate if the validation loss plateaus. The second scheduler was used for the Frangieh21 dataset, which reduces the learning rate by a factor 5 if the validation loss does not decrease for 15 consecutive epochs. The entire perturbation response model 202 is trained end to end with the MSE loss backpropagated through the entire network.

To deploy a trained perturbation response model to generate counterfactual predictions, perturbations and covariates (i.e. culture condition) to be predicted are initially identified. For every unique perturbation and set of covariates, a set of control cells with matched covariates (as described above) is identified, and those control cells and perturbations are used as inputs to the perturbation response model. Using the Frangieh21 example dataset, to predict the effect of knocking out gene A in the co-culture condition, 1000 control cells are sampled from the co-culture condition, and the trained perturbation response model is used to generate 1000 predicted perturbed cells. A default of 1000 cells is sampled per unique perturbation/set of covariates.

The fidelity of the above perturbation response model was assessed using multiple metrics, including cosine similarity and cosine similarity rank. More specifically, the cosine similarity of average predicted vs observed log fold-changes is defined as:

$${S}_{c o s i n e} ( L , \hat{L} ) = \frac{{\sum }_{i = 0}^{n - 1} {l}_{i} \hat{{l}_{ι}}}{\sqrt{{\sum }_{i = 0}^{n - 1} {l}_{i}^{2}} \sqrt{{\sum }_{i = 0}^{n - 1} {\hat{{l}_{ι}}}^{2}}}$$

Where lᵢ is the observed log fold-change and [symbol] is the predicted log fold-change for gene i. Log fold-change is computed using the equation:

$${l}_{i} = {log}_{2} ( \frac{{μ}_{i}^{p} + ε}{{μ}_{i}^{c} + ε} )$$

Where μᵢ^{p} is the average expression of the perturbed cells (either predicted or measured) and μᵢ^{c} is the average expression of the sampled control cells used to generate the predictions. ε is a pseudocount used to avoid division by zero and is set to 0.1. L denotes the vector of log fold-changes across all genes.

For the Frangieh21 dataset, all predictions include 1000 cells per unique perturbation and set of covariates. The number of observed cells per unique perturbation and set of covariates differs depending on the perturbation.

A rank-based metric that measures how well the predicted perturbations are ordered is also used. Specifically, for a given observed perturbation, the prediction for that perturbation should be more similar than predictions for other perturbations. The rank metric is computed on a per perturbation basis:

$$rank ( {\hat{L}}_{j} ) = \frac{1}{p - 1} {{\sum }_{k = 0 ,}^{p - 1}}_{k != j} 𝕀 ( {S}_{c o s i n e} ( {\hat{L}}_{k} , {L}_{j} ) \geq {S}_{c o s i n e} ( {\hat{L}}_{j} , {L}_{j} ) )$$

Where \hat{L}ⱼ is a vector of predicted log fold-changes with length equal to the number of genes in the dataset, and Lⱼ is a vector of observed log fold-changes with the same length. The index j refers to the perturbation and p is the total number of perturbations in the evaluation set.

Predictions for the test split, which includes 87 perturbations in the co-culture condition, were generated and evaluated. For each predicted perturbation, the cosine similarity and cosine similarity rank metrics were predicted, and average metrics across the 87 perturbations are reported below. The Random row indicates the metrics that would be expected if the perturbation response model reported completely random results. The Perfect row indicates the metrics that would be expected if the perturbation response model predicted the perturbation gene expression effects perfectly.

| | Cosine Similarity | Cosine Similarity Rank |
|---|---|---|
| Perturbation | 0.17 | 0.26 |
| Response Model | | |
| Random | 0.0 | 0.5 |
| Perfect | 1.0 | 0.0 |

As shown in the above results, the trained perturbation response model is able to predict expression changes due to perturbation in a non-trivial fashion.

### Example Cell State Model

As described above, a cell state model outputs a measurable attribute indicating the health of a biological system given gene expression values as input. These attributes include but are not limited to: 1) predicting the chronological age of a donor sample, 2) predicting the probability that a cell or a sample originated from a donor with a disease vs a healthy donor, 3) predicting a donor-level biomarker that measures disease magnitude.

An example cell state model can be trained using a Jerby-Arnon18 dataset. The Jerby-Arnon18 dataset is a single-cell RNA-sequencing dataset of malignant melanoma cells from 22 patients, 12 of which are treatment naïve and 10 of which did not respond to anti-programmed cell death protein 1 (PD-1) immunotherapy. This falls under the 2^{nd} type of target state attribute outlined above. The melanoma cells from the treatment naïve patients are assumed contain a mix of cells that are immunogenic and immune evasive, while the melanoma cells of non-responding patients are assumed to contain mostly immune evasive cells. The goal was to build a classifier that could classify cells as either naïve or nonresponsive, using the non-responsive label as a proxy for immune evasion. This resulted in a filtered scRNA-seq dataset with 1,101 naïve melanoma cells and 825 nonresponsive melanoma cells. Each cell contains gene expression counts and a naïve/non-responsive label.

The dataset is randomly divided into 70% cells for training and 30% cells for test, with the split stratified by the naïve/non-responsive label to ensure class balance in each split.

The same preprocessing protocol as described with respect to the example perturbation response model above was used with the Jerby-Anon18 dataset. During preprocessing, this dataset was subsetted to 6,664 genes that were significantly differentially expressed between the naïve and non-responsive cells in the training split. Differentially expressed is defined as having an adjusted p-value of less than 0.01 using the Wilcoxon test as implemented in scanpy.tl.rank_genes_group. This differential expression was run using only the cells from the training split to avoid the possibility of information leakage.

The cell state model can take many different architectures but will generally be a classifier or regression model. For the Jerby-Arnon18 dataset, a linear classifier with an elastic net penalty was used to reduce overfitting. The input to the example cell state model is the normalized gene expression profile of the cell of length 6,664, and the output is a probability between 0 and 1, where 1 signifies that the cell is likely to be naïve and 0 signifies that the cell is likely to be non-responsive.

Formally, the cell state model is a function mapping a gene expression vector to a probability:

$${p}_{i} = f ( {x}_{i} )$$

Where pᵢ is the probability that the cell is from a non-responsive donor and xᵢ is the cell's normalized gene expression vector of length 6,664.

During training of the example cell state model, the LogisticRegressionCV class from scikit-learn was used to identify the optimal L1 and L2 penalty hyperparameters using 4-fold cross validation over the train split. Specifically, the training process iterated over 20 penalty strengths, with the exact penalty strength sequence chosen by the cell state model. The training process also iterated over 8 L1/L2 ratios, specifically [0, 0.1, 0.3, 0.5, 0.7, 0.9, 0.95, 1]. The optimal cell state model had a penalty strength of 1.623 and an L1/L2 ratio of 0.1. The saga solver was used with an error tolerance of 0.001 and a maximum of 100 epochs.

After training, the optimal cell state model was used to predict the naïve/non-responsive labels in the test split, given the gene expression data. Since a linear model was used for the Jerby-Arnon18 dataset, the target state inference can be expressed as:

$${p}_{i} = w {x}_{i} + c$$

Where w is a vector of length 6,664 representing the model weights and c is a constant offset that also has the form of a vector of length 6,664. Other cell state models can take the form of MLPs, random forest classifiers, and/or other types of machine learning architectures.

The accuracy of the cell state model was quantified using the receiver operating characteristic (ROC) curve, which plots the true positive rate against the false positive rate. The area under the ROC curve (AUC) indicates how well a binary classifier performs.

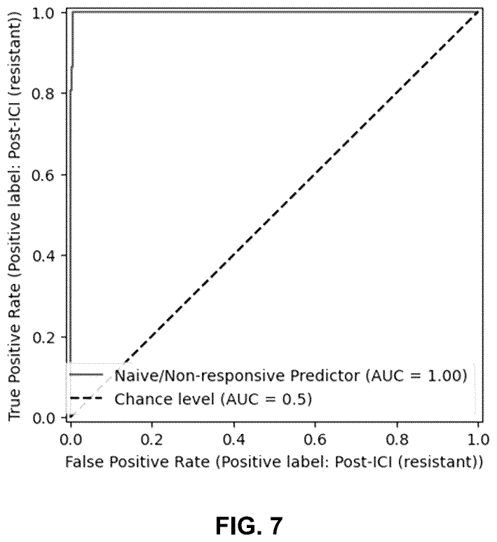

FIG. 7 shows a ROC curve representing the performance of an example cell state model, in accordance with various embodiments. As shown in FIG. 7, the cell state model achieves a very strong performance in terms of ability to distinguish non-responsive vs naïve melanoma cells.

### Predicting Regulators of Immune Evasion in Melanoma Cells Using the Example Perturbation Response and Cell State Models

Predicted cells for the Frangieh21 test split, which included 87 perturbations in the co-culture condition, were generated, with 1000 cells generated for each perturbation. The cell state model was then used to predict the non-response score for each predicted cell. Only 2,508 genes in the perturbation response model predictions overlapped with the target state model genes, so the remaining 4,156 genes were padded with zeros for all cells.

For each perturbation in the test split, the predicted non-response scores for all cells with that perturbation were averaged, resulting in average predicted non-response for 87 perturbations. The non-response scores were ranked, and the top 5 gene knockouts predicted to cause immunotherapy non-response in melanoma are listed below.

| Perturbation | Rank |
|---|---|
| JAK1 | 1 |
| IFNGR1 | 2 |
| JAK2 | 3 |
| CDKN2B | 4 |
| CDKN1A | 5 |

The top 3 perturbations are related to the JAK1, JAK2, and the IFN-γ receptor. In cancers, IFN-γ is secreted by cytotoxic T-cells and binds to its receptor on melanoma cells, activating the JAK/STAT/IRF1 signaling pathways which eventually results in PD-L1 expression. High levels of PD-L1 expression have been shown to be predictive of anti-PD-1 immunotherapy response in the clinic, which suggests that blocking PD-L1 expression by knocking out either the IFN-γ receptors or elements of the JAK/STAT/IRF1 signaling pathway could cause non-response. The next two perturbations are CDKN2B and CDKN1A (aka p16). Knocking out senescence regulators such as p16/CDKN1A is known to reduce immunotherapy effectiveness. CDKN2B is a known negative regulator of CDK4 and inhibiting CDK4 in mouse melanoma models improves immunotherapy effectiveness. Consequently, all 5 of the top perturbations suggested by the combination of the example perturbation response model and cell state model have direct links to immunotherapy resistance.

In sum, the disclosed techniques train and execute multiple sets of machine learning models to perform perturbation response and target cell state modeling. One or more perturbation response models are trained to predict responses of one or more biological systems to genetic, chemical, and/or other types of perturbations. For example, the perturbation response model(s) could include compositional perturbational autoencoders (CPAs) and/or other types of deep learning models with encoder-decoder architectures. Encoders in the perturbation response model(s) could be used to generate embeddings representing basal states, cell types, perturbations, and/or covariates associated with the biological systems. Decoders in the perturbation response model(s) could be used to decode combinations of the embeddings into gene expressions, images, proteins, and/or other output representing responses of the biological systems to the perturbations.

One or more cell state models are trained to predict cell states corresponding to the perturbation responses generated by the first set of machine learning models. For example, the cell state model(s) could include nonlinear regression models, deep learning models, and/or other types of machine learning models that convert gene expressions, images, proteins, and/or other data indicative of responses of biological systems to perturbations into biological ages, health or disease statuses, cell types, phenotypes, and/or other cell states corresponding to the representations.

After training is complete, the two sets of machine learning models are integrated into a feedback loop of in silico and physical experiments to accelerate the discovery of interventions that are likely to improve health and/or rejuvenation in the biological systems. More specifically, the perturbation response model(s) can be used to explore perturbation responses across cell types, disease conditions, basal states, covariates, modalities, perturbation types, perturbation combinations, and/or other variables. Perturbation responses generated by the perturbation response model(s) can then be inputted into the cell state model(s), and predictions of cell states generated by the cell state model(s) from the inputted perturbation responses can be used to identify a subset of perturbations that are likely to rejuvenate and/or otherwise improve the health of various types of cells. The identified perturbations can then be validated using various experimental screens, and results of the experimental screens can be used to retrain one or both sets of machine learning models.

One technical advantage of the disclosed techniques relative to the prior art is the ability to predict responses of different biological systems to various combinations of perturbations and predict cell states corresponding to the responses. The disclosed techniques can thus be used to identify perturbations that are likely to lead to improved biological ages, health states, phenotypes, and/or other target cell states without requiring time- and resource-intensive experiments to determine the effects of the perturbations on the biological systems. Another technical advantage of the disclosed techniques is the ability to focus limited computational and/or experimental resources on promising perturbations that are likely to result in the target cell states within the biological systems. Consequently, the disclosed techniques allow interventions that improve health and rejuvenation in the biological systems to be prioritized and verified in a targeted manner, thereby improving the exploration and understanding of biological rejuvenation across a large and complex search space of perturbations. These technical advantages provide one or more technological improvements over prior art approaches.

### Example Clauses

CLAUSE 1: In various embodiments, a computer-implemented method, comprising predicting, using one or more perturbation response models configured to take as input one or more basal states associated with one or more biological systems and a first plurality of perturbations, a first plurality of responses of the one or more biological systems to the first plurality of perturbations, wherein the one or more perturbation response models have been trained to reconstruct a first plurality of training samples, each of the first plurality of training samples comprising a basal state of a biological system, one or more covariates associated with the biological system, and one or more perturbations applied to the biological system, predicting, using one or more cell state models configured to take as input the first plurality of responses, a first plurality of cell states associated with the first plurality of responses, wherein the one or more cell state models have been trained using a second plurality of training samples comprising observations of a plurality of biological systems paired with a second plurality of cell states, and selecting one or more additional perturbations included in the first plurality of perturbations for experimental evaluation based on the first plurality of cell states.

CLAUSE 2. The computer-implemented method of clause 1, further comprising receiving one or more results associated with the experimental evaluation, generating a training dataset that includes the one or more results and the one or more perturbations, and retraining the one or more perturbation response models using the training dataset.

CLAUSE 3. The computer-implemented method of clause 1 or 2, further comprising training the one or more perturbation response models using at least one of a reconstruction loss or an adversarial loss.

CLAUSE 4. The computer-implemented method of any of clauses 1-3, further comprising training the one or more cell state models using a mean squared error.

CLAUSE 5. The computer-implemented method of any of clauses 1-4, wherein predicting the first plurality of responses comprises: generating, using the one or more perturbation response models, one or more embeddings corresponding to the one or more basal states and a first plurality of embeddings representing the first plurality of perturbations, combining the one or more embeddings corresponding to the one or more basal states with the first plurality of embeddings representing the first plurality of perturbations to produce a plurality of unified embeddings, and converting the plurality of unified embeddings into the first plurality of responses.

CLAUSE 6. The computer-implemented method of any of clauses 1-5, wherein predicting the first plurality of cell states comprises: inputting one or more responses included in the first plurality of responses into a regression model included in the one or more cell state models, and executing the regression model to convert the one or more responses into one or more cell states for a corresponding biological system.

CLAUSE 7. The computer-implemented method of any of clauses 1-6, wherein determining the one or more perturbations comprises: generating a plurality of scores for the first plurality of perturbations based on the first plurality of cell states, and determining the one or more perturbations based on a ranking of the first plurality of perturbations by the plurality of scores.

CLAUSE 8. The computer-implemented method of any of clauses 1-7, wherein the one or more perturbation response models is further configured to take as input one or more covariates comprising information indicative of at least one of a cell line, a disease state, or a phenotype.

CLAUSE 9. The computer-implemented method of any of clauses 1-8, wherein the one or more basal states comprise information indicative of a state of a biological system in an absence of the first plurality of perturbations and the first plurality of responses comprises information indicative of a plurality of states of the biological system when exposed to the first plurality of perturbations.

CLAUSE 10. The computer-implemented method of any of clauses 1-9, wherein the first plurality of perturbations comprises at least one of a chemical perturbation or a genetic perturbation.

CLAUSE 11. One or more non-transitory computer-readable media storing instructions that, when executed by one or more processors, cause the one or more processors to perform the steps of: predicting, using one or more perturbation response models configured to take as input one or more basal states associated with one or more biological systems and a first plurality of perturbations, a first plurality of responses of the one or more biological systems to the first plurality of perturbations, wherein the one or more perturbation response models have been trained to reconstruct a first plurality of training samples, each of the first plurality of training samples comprising a basal state of a biological system, one or more covariates associated with the biological system, and one or more perturbations applied to the biological system, predicting, using one or more cell state models configured to take as input the first plurality of responses, a first plurality of cell states associated with the first plurality of responses, wherein the one or more cell state models have been trained using a second plurality of training samples comprising observations of a plurality of biological systems paired with a second plurality of cell states, and selecting one or more additional perturbations included in the first plurality of perturbations for experimental evaluation based on the first plurality of cell states.

CLAUSE 12. The one or more non-transitory computer-readable media of clause 11, wherein the instructions further cause the one or more processors to perform the steps of: determining one or more results associated with the experimental evaluation, generating a training dataset that includes the one or more results and the one or more perturbations, and retraining the one or more perturbation response models or the one or more cell state models using the training dataset.

CLAUSE 13. The one or more non-transitory computer-readable media of clause 11 or 12, wherein the instructions further cause the one or more processors to perform the step of training the one or more perturbation response models using a reconstruction loss and an adversarial loss.

CLAUSE 14. The one or more non-transitory computer-readable media of any of clauses 11-13, wherein the instructions further cause the one or more processors to perform the steps of training the one or more cell state models using a plurality of biological ages and a plurality of health statuses corresponding to the second plurality of cell states.

CLAUSE 15. The one or more non-transitory computer-readable media of any of clauses 11-14, wherein training the one or more cell state models comprises: training a base model included in the one or more cell state models to take as input the observations and produce as output the plurality of biological ages and the plurality of health statuses, initializing a plurality of tissue-specific models using the base model, and training the plurality of tissue-specific models using a plurality of tissue-specific datasets.

CLAUSE 16. The one or more non-transitory computer-readable media of any of clauses 11-15, wherein the plurality of tissue-specific datasets is associated with at least one of kidney cells, endothelial cells, fibroblast cells, neural cells, or muscle cells.

CLAUSE 17. The one or more non-transitory computer-readable media of any of clauses 11-16, wherein determining the one or more perturbations comprises matching one or more cell states associated with the one or more perturbations to one or more target cell states for the one or more biological systems.

CLAUSE 18. The one or more non-transitory computer-readable media of any of clauses 11-17, wherein the one or more cell state models comprise a multilayer perceptron.

CLAUSE 19. The one or more non-transitory computer-readable media of any of clauses 11-18, wherein the one or more perturbation response models comprise a compositional perturbation autoencoder.

CLAUSE 20. A system, comprising: one or more memories that store instructions, and one or more processors that are coupled to the one or more memories and, when executing the instructions, are configured to perform the steps of: predicting, using one or more perturbation response models configured to take as input one or more basal states associated with one or more biological systems and a first plurality of perturbations, a first plurality of responses of the one or more biological systems to the first plurality of perturbations, wherein the one or more perturbation response models have been trained to reconstruct a first plurality of training samples, each of the first plurality of training samples comprising a basal state of a biological system, one or more covariates associated with the biological system, and one or more perturbations applied to the biological system, predicting, using one or more cell state models configured to take as input the first plurality of responses, a first plurality of cell states associated with the first plurality of responses, wherein the one or more cell state models have been trained using a second plurality of training samples comprising observations of a plurality of biological systems paired with a second plurality of cell states, and selecting one or more additional perturbations included in the first plurality of perturbations for experimental evaluation based on the first plurality of cell states.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
predicting, using one or more perturbation response models configured to take as input one or more basal states associated with one or more biological systems and a first plurality of perturbations, a first plurality of responses of the one or more biological systems to the first plurality of perturbations, wherein the one or more perturbation response models have been trained to reconstruct a first plurality of training samples, each of the first plurality of training samples comprising a basal state of a biological system, one or more covariates associated with the biological system, and one or more perturbations applied to the biological system;
predicting, using one or more cell state models configured to take as input the first plurality of responses, a first plurality of cell states associated with the first plurality of responses, wherein the one or more cell state models have been trained using a second plurality of training samples comprising observations of a plurality of biological systems paired with a second plurality of cell states; and
selecting one or more additional perturbations included in the first plurality of perturbations for experimental evaluation based on the first plurality of cell states.

2. The computer-implemented method of claim 1, further comprising:
receiving one or more results associated with the experimental evaluation;
generating a training dataset that includes the one or more results and the one or more perturbations; and
retraining the one or more perturbation response models using the training dataset.

3. The computer-implemented method of claim 1, further comprising training the one or more perturbation response models using at least one of a reconstruction loss or an adversarial loss.

4. The computer-implemented method of claim 1, further comprising training the one or more cell state models using a mean squared error.

5. The computer-implemented method of claim 1, wherein predicting the first plurality of responses comprises:
generating, using the one or more perturbation response models, one or more embeddings corresponding to the one or more basal states and a first plurality of embeddings representing the first plurality of perturbations;
combining the one or more embeddings corresponding to the one or more basal states with the first plurality of embeddings representing the first plurality of perturbations to produce a plurality of unified embeddings; and
converting the plurality of unified embeddings into the first plurality of responses.

6. The computer-implemented method of claim 1, wherein predicting the first plurality of cell states comprises:
inputting one or more responses included in the first plurality of responses into a regression model included in the one or more cell state models; and
executing the regression model to convert the one or more responses into one or more cell states for a corresponding biological system.

7. The computer-implemented method of claim 1, wherein determining the one or more perturbations comprises:
generating a plurality of scores for the first plurality of perturbations based on the first plurality of cell states; and
determining the one or more perturbations based on a ranking of the first plurality of perturbations by the plurality of scores.

8. The computer-implemented method of claim 1, wherein the one or more perturbation response models is further configured to take as input one or more covariates comprising information indicative of at least one of a cell line, a disease state, or a phenotype.

9. The computer-implemented method of claim 1, wherein the one or more basal states comprise information indicative of a state of a biological system in an absence of the first plurality of perturbations and the first plurality of responses comprises information indicative of a plurality of states of the biological system when exposed to the first plurality of perturbations.

10. The computer-implemented method of claim 1, wherein the first plurality of perturbations comprises at least one of a chemical perturbation or a genetic perturbation.

11. One or more non-transitory computer-readable media storing instructions that, when executed by one or more processors, cause the one or more processors to perform the steps of:
predicting, using one or more perturbation response models configured to take as input one or more basal states associated with one or more biological systems and a first plurality of perturbations, a first plurality of responses of the one or more biological systems to the first plurality of perturbations, wherein the one or more perturbation response models have been trained to reconstruct a first plurality of training samples, each of the first plurality of training samples comprising a basal state of a biological system, one or more covariates associated with the biological system, and one or more perturbations applied to the biological system;
predicting, using one or more cell state models configured to take as input the first plurality of responses, a first plurality of cell states associated with the first plurality of responses, wherein the one or more cell state models have been trained using a second plurality of training samples comprising observations of a plurality of biological systems paired with a second plurality of cell states; and
selecting one or more additional perturbations included in the first plurality of perturbations for experimental evaluation based on the first plurality of cell states.

12. The one or more non-transitory computer-readable media of claim 11, wherein the instructions further cause the one or more processors to perform the steps of:
determining one or more results associated with the experimental evaluation;
generating a training dataset that includes the one or more results and the one or more perturbations; and
retraining the one or more perturbation response models or the one or more cell state models using the training dataset.

13. The one or more non-transitory computer-readable media of claim 11, wherein the instructions further cause the one or more processors to perform the step of training the one or more perturbation response models using a reconstruction loss and an adversarial loss.

14. The one or more non-transitory computer-readable media of claim 11, wherein the instructions further cause the one or more processors to perform the steps of training the one or more cell state models using a plurality of biological ages and a plurality of health statuses corresponding to the second plurality of cell states.

15. The one or more non-transitory computer-readable media of claim 14, wherein training the one or more cell state models comprises:
training a base model included in the one or more cell state models to take as input the observations and produce as output the plurality of biological ages and the plurality of health statuses;
initializing a plurality of tissue-specific models using the base model; and
training the plurality of tissue-specific models using a plurality of tissue-specific datasets.

16. The one or more non-transitory computer-readable media of claim 15, wherein the plurality of tissue-specific datasets is associated with at least one of kidney cells, endothelial cells, fibroblast cells, neural cells, or muscle cells.

17. The one or more non-transitory computer-readable media of claim 11, wherein determining the one or more perturbations comprises matching one or more cell states associated with the one or more perturbations to one or more target cell states for the one or more biological systems.

18. The one or more non-transitory computer-readable media of claim 11, wherein the one or more cell state models comprise a multilayer perceptron.

19. The one or more non-transitory computer-readable media of claim 11, wherein the one or more perturbation response models comprise a compositional perturbation autoencoder.

20. A system, comprising:
one or more memories that store instructions, and
one or more processors that are coupled to the one or more memories and, when executing the instructions, are configured to perform the steps of:
predicting, using one or more perturbation response models configured to take as input one or more basal states associated with one or more biological systems and a first plurality of perturbations, a first plurality of responses of the one or more biological systems to the first plurality of perturbations, wherein the one or more perturbation response models have been trained to reconstruct a first plurality of training samples, each of the first plurality of training samples comprising a basal state of a biological system, one or more covariates associated with the biological system, and one or more perturbations applied to the biological system;
predicting, using one or more cell state models configured to take as input the first plurality of responses, a first plurality of cell states associated with the first plurality of responses, wherein the one or more cell state models have been trained using a second plurality of training samples comprising observations of a plurality of biological systems paired with a second plurality of cell states; and
selecting one or more additional perturbations included in the first plurality of perturbations for experimental evaluation based on the first plurality of cell states.
